(19) United States
(12) Patent Application Publication
(10) Pub. No.: US 2002/0143920 A1
(43) Pub. Date: Oct. 3, 2002

(54) Service monitoring and reporting system

(75) Inventors: Roger Dev, Durham, NH (US); Eric Rustici, Londonderry, NH (US); Andrei Pandre, Acton, MA (US); Wallace Matthews, Mendon, MA (US)

Correspondence Address: NUTTER MCCLENNEN & FISH LLP, WORLD TRADE CENTER WEST, 155 SEAPORT BOULEVARD, BOSTON, MA, 02110-2604, US

(73) Assignee: OPTICOM, INC.

(21) Appl. No.: 10/113,199

(22) Filed: Mar. 28, 2002

Related U.S. Application Data
(60) Provisional application No. 60/280,227, filed on Mar. 30, 2001.

(51) Int. Cl. G06F 15/173

(52) U.S. Cl. 709/223; 709/224

(57) ABSTRACT

A system and method for detecting or reporting service level or service outages on a network includes a meta service generator that operates on a network inventory to generate service definitions. The system is a server-based model, and each service definition includes usergroup and points of presence, thus instantiating multiple services in a manner that allows the definition to focus on relevant element events amid massive network event data, and detect service outages quickly and dependably. The outages, transaction spec outages and events so determined may be aggregated to provide overall measures that are compared with thresholds, performance criteria and other service metrics specified in a user Service Level Agreement (SLA) for billing, credit, evaluation or other purposes. Batch processing embodiments may operate with outage logs, and employ a concurrence algebra to correct outage intervals for planned and forced outages, providing a truer measure of performance that allows the system to generate multiple different reports reflecting different compensable or inconsequential outage states.

### REFERENCE TO RELATED APPLICATION

The present application claims priority to provisional application No. 60/280,227, entitled “SERVICE MONITORING AND REPORTING SYSTEM,” filed on Mar. 30, 2001, and herein incorporated by reference. The present application is also related to United States patent application entitled Service Level Monitoring Technology, filed on Jul. 14, 2000, and having a Ser. No. 09/616,557. That application, describing a system for monitoring and quantifying service in a network, is hereby incorporated herein by reference in its entirety.

That application describes a system operating in the context of a Service Level Agreement based upon performance thresholds and contracted hours, and monitoring multiple concurrent services, which are considered available when all aspects of the service are within pre-defined acceptable ranges. Various aspects of a service can include, for example, the basic functioning of the service (i.e., whether it is up or down); the level of performance such as its bandwidth, speed of operation, timing aspects; and other qualitative and/or quantitative measures defining the performance level of the service.

The system of that application operates by receiving a plurality of event streams, e.g., state changes of equipment, ordering and merging these streams, and using the merged records to determine service outages and performance measures. Many of its teachings will be assumed herein for operation of such a system and application of service metrics, and reference is made thereto for general descriptions of techniques for collection and evaluation of service-related data.

### BACKGROUND OF THE INVENTION

The present invention relates generally to network system service monitoring, and more particularly to systems and methods for monitoring, recording and reporting information regarding operation and availability of service on a network or networked communications system.

Service is a widely used term within the communications and computer industry. However, it is not concisely defined, and is best understood by considering a range of examples. A service may consist of access to the Internet, the use of a communications channel, a pre-delivered telephone connection time (e.g., a selected number of minutes per month), or other provision of or access to equipment or links. Service is a function provided by a provider (called the service provider) to someone who wishes to use the service. The provider and the user may expressly formulate and agree upon the definition of an individual service. When a service provider, such as a telephone company, provides a service to an end-user, there may be either an explicit or an implicit understanding between the service provider and the user regarding an acceptable level of the performance of the service. The terms of such an understanding may be explicitly defined and memorialized in a contract, or they may remain as implicit expectations shared between the service provider and the end-user. Explicit agreements may specify a baseline level of bandwidth, availability or response time of the service. A service provider is contractually obligated to adhere to such expected baseline levels of the performance of the service. When the agreement is implicit, exact levels may not be articulated, but the service level remains an important business metric. If the actual service level taxes the threshold of employees' tolerance, or results in down time, this may be taken as a breach of the implied contract, and may cause real losses that may be legally redressed. However, for many services, a provider advertises the service without expressly defining the limits or range of what the service comprises, and a user subscribes to the advertised service without further articulating its own expectations. In some cases, the user pays a fee for the service, for example, a flat fee. Some services are defined as a bundle of services. These may include services that are metered as well as other flat fee add-ons or ancillary services. In addition, a service may include other services. For example, Service Provider may offer a service that provides a user who has access to a port on the Provider's network, access to the Internet through the Provider's Internet Gateway. This is a very general service with no specified hours of access, no limit specified on how many packets an hour will be supported, or what response time is to be expected. Within this service may be other services that are much more specifically defined. Each of those may be bundles of other services.

Often, a service provider provides services for large organizations such as a bank, brokerage or insurance company, a manufacturing concern or a marketing entity linked by the provider's network and using the provider's equipment. The client may rely upon its systems to carry out a specified volume of transactions or service tasks through numerous hardware, software and human elements connected to the network. This introduces a further layer of complexity in defining a service.

Network communications are critically involved with all such types of service, and for a number of management functions it would seem desirable to precisely determine the effective level of service, or service availability

In the network industry within the last few years, service providers have introduced two important concepts. The first is Quality of Service, where each user of a service identifies differing levels of service (and agreed upon price differentials) that they require. An example in the electrical power industry is that customers agree to allow the service provider to limit their use during peak periods in exchange for a rate lower than the generally applied rate. A data network user may agree to accept longer delays, greater probability of lost packets, and applications time outs in exchange for a lower access cost. The second is a Service Level Agreement (herein termed an SLA). An SLA is the formal description of the agreement about the Quality of Service needs of the user and the commitment of the service provider to supply it. Once such an agreement is in place, it would be desirable to monitor the provision of service and determine the degree of compliance with the SLA. However, the definition of a service may be complex or elusive, and may not be readily correlated with the network functions normally monitored by a management system.

Currently, network management programs tend to operate by the use of various probes, or employ specialized polling to determine status or detect the failure or down time of individual communications links, components or applications in the network. Monitoring device status and failure conditions in this manner may be effective for planning timely troubleshooting and repair, as well as for overall quality assessment of network devices in a manner that may be useful when purchasing or replacing components. However, this type of network report or knowledge may bear little relation to the actual service performance which is the ultimate reason the network exists. Indeed, substantial guesswork may be required to establish some relationship between available measurements and the levels of service.

Accordingly, there is a need to provide a management system for determining service metrics, such as metrics of usage, availability, speed or quality of a provided service.

There is also a need to provide a management system configured to assess and report information regarding the performance of service, wherein the system may be configured for different situations and diverse services.

There is also a need for a management system that is configured to define services, to evaluate or monitor the provision of the defined services on a network, and to compare the level of services using one or more metrics with services specified in an SLA.

### SUMMARY OF THE INVENTION

One or more of the foregoing benefits are achieved in accordance with the present invention by a system and method that maintains service definitions, and employs these definitions to monitor and report service level or status in a network. The system includes a set of service definitions defining a service that depends on one or more physical and/or logical elements of the computer network, and has associated dependency structure used, for example, to locate metering locations—e.g., equipment, links or nodes—that may be monitored for usage/status and support inferences to provide a metric value of the service.

The system executes, e.g., daily or otherwise, a configuration process using rule based files to redefine its service definition set. The rule based service redefinition files may be called meta-service files, and may utilize a variety of mechanisms to define the hierarchy of services. These may be defined at least in part by using different hierarchical organizations, such as location or corporate grouping, so as to address and probe elements in a service providers network that are addressable via SNMP and support standard SNMP MIBs. The system may search the network to identify or infer the existence of elements that are maintained as a current (e.g., daily) inventory, and the inventory is then scanned by a rule based process to identify elements that are access points for users—i.e., POPs. The POPs are then processed against the meta-service rule definitions to provide updated service definitions.

This allows for set of services to be dynamic. As new users for a customer are added, their POPs are identified and added to the service definitions. As old users disappear, so possibly, can their POPs. If an administrator changes a parameter such as cost, then it gets changed during the development of the new service definition. The meta-service parameter values may accept regular expressions or wild cards as well as specific entries. This, together along with the use of hierarchy in most of them, allows a very compact and efficient specification process.

The definitions support metrics that characterize the service level experienced by user(s) of the service, allowing generation of cost and compliance reports. They may also be employed to generate Service Level Agreements, contracted hours, planned outages, and any other service parameter.

The system monitors performance and produces outage reports in both contiuous and batch (historical reporting) processing modes, and accounts for planned and forced events to accurately reflect measures under an SLA or other metrics. Variations of the invention include the provision of a proto-service generator in lieu of a meta-service generator. Particular processing for generating logs and reports may include an element outage generator, that receives raw element events, including loss-of-contact events and an end-of period indicator, and a transaction outage synthesizer that receives raw transaction results including loss-of-contact and end-of period indicators. The outage generator and synthesizer may receive, or determine planned outages as well as detected or inferred outages, and generate reports accordingly for the intended use, so that, for example equipment down time that does not affect a service, and service down time that has been scheduled, are not counted as breach of an SLA. The system implements various financial metrics for directly adjusting billing or otherwise documenting SLA terms and performance standards.

Illustrative embodiments of the invention will be described below in reference to the following drawings.

### BRIEF DESCRIPTION OF THE DRAWINGS

FIG. 1A is a schematic diagram depicting overall operation of a system according to the teachings of the invention;

FIG. 1B is a schematic diagram depicting operation of another system according to the teachings of the invention;

FIG. 2 is a chart depicting the modules in a system for continuous generation of data for service outage determinations and preparation of logs for element, transaction and service logs; and

FIG. 3 schematically depicts batch processing and report generation.

### DETAILED DESCRIPTION OF THE INVENTION

The present invention provides a system and method for use in a networked communications system to monitor and record the status value and other metrics of service provided on the network, for example to bill for services, or evaluate compliance with a service level agreement (SLA) governing those services. The operation of the system and distinction over the prior art will be understood in the context of the need to define metrics or evaluate the actual provision of services in a networked environment where many different customers organizations or work groups may be using the communications links and different units of equipment within the network, and wherein each may require documentation of its service level even though the specific equipment, links, hours of use and the like may change from time to time and a customer may have been unaffected by an equipment outage that was potentially related to a contracted service.

The invention addresses the relatively complex distinctions involved in defining service in connection with different users, locations and intended purposes. In this context, a service includes a name (a unique identification of a service) and a customer—conceptually a collection of users, which will generally be the agent responsible for all user charges for a named service. Further, the system is configured to apply functions to system monitoring outputs to define metrics indicating performance, availability and error-rate for the specific named services, typically defining thresholds for minimum levels of performance, availability, errors or the like. Preferably metered performance is compared to defined thresholds, taking into account contracted hours and outages, that is hours that a user has contracted for the service, and the periods of interruption of the service.

Systems of the invention operate as described more fully below to instantiate a service, produce various levels of outage data, and perform batch processing to provide billing and credit information, or more generally automated management information and monitoring, for the services that the system models.

By way of overview, the system contains a set of service definitions within a directory that contains its set of defined services. These definitions use natural language similar to what has been historically used for Operating Systems command lines, e.g., they are in English, are readable, and are useful as diagnostic aids. Rather than creating the definitions by using a standard text editor and having a trained person enter definitions of services while taking into account their syntactic structure, the invention provides a service-defining generator module. The service definitions are maintained at intervals, e.g., periodically (daily or at specified times which may be changed through configuration), by executing a configuration program that uses rule based files to re-define its service definition set.

These rule based service re-definition files, or “meta-service files” may reside in their own directory and may be interconnected using embedded import statements that follow the importing rules that most high level languages use. The meta-service files may use a variety of rule based mechanisms to define the hierarchy of services. By way of example, hardware elements in a service provider's network may be manageable via SNMP and support standard SNMP management information base (MIB) variables. One of the standard MIB variables is ‘Location’. Service providers generally have hierarchical naming conventions for the values of ‘Location’ such as ‘INTL/UK/LONDON/SOHO/RACK4’ so that a user, upon seeing this value, can identify that the device is located in Rack 4 of the Soho Office in London, England. In defining a service implicating that equipment, or a user group to whom that equipment is dedicated, the system can have one rule in the meta-service that says to use the top 3 levels of the ‘Location’ value convention to build a hierarchy of services that follow that convention. (Then, for example, a top level service called say ‘XYZ’, a secondary one called ‘XYZ/intl’, a third called ‘XYZ/intl/uk’.) All elements key to the service with the prefix ‘INTL/UK’ could be elements of the service. Whether they are or not would depend upon other rules. Other rules for identifying elements of a service are address ranges, element naming conventions, topology mapping rules, and network management proprietary containment structures. Others may be added as they are identified in an existing network or organizational structure, or as appropriate to define new or desirable rules for identifying a service.

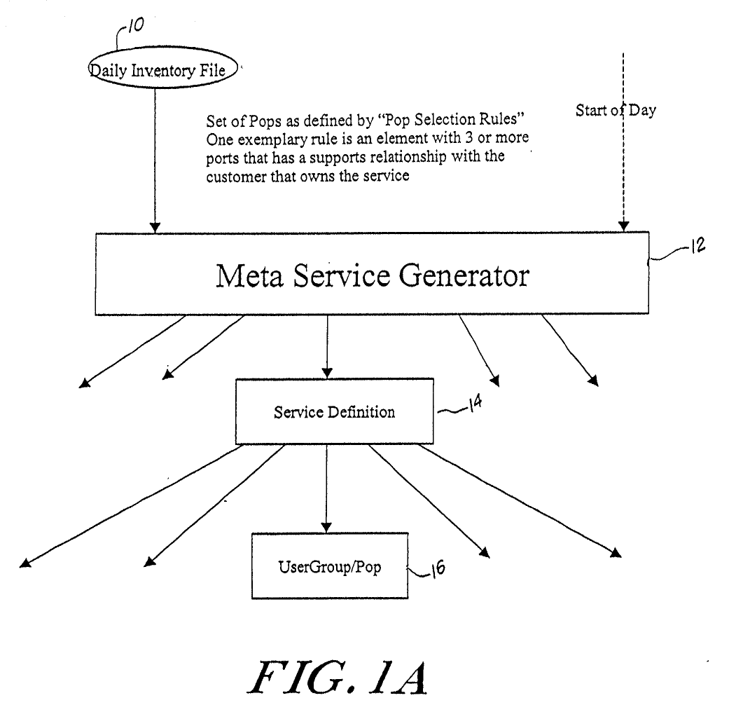

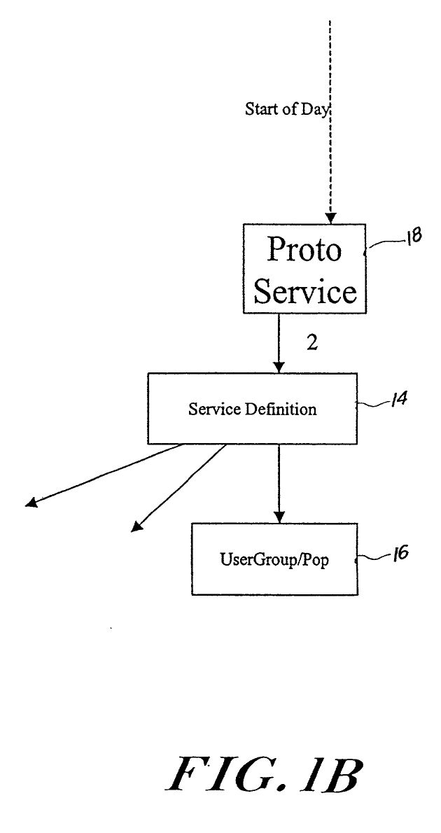

With reference to FIGS. 1A and 1B, the service definitions are generated automatically at the start of a period—for example each day they are generated from the daily inventory file of the system. A daily inventory file 10 is built up by searching the network using a number of mechanisms to directly identify or infer the existence of elements that are then maintained as the daily inventory. The inventory is scanned by a rule based process to identify elements that are access points for users (i.e. POPs). The rules may contain manually-configured adds and deletes to handle exceptions. The results of these scans are provided to a ‘meta_service_generator’ module 12 as a set of POPs to be processed against the set of meta-service rule definitions 14. The results will be a set of updated service definitions. This allows for set of services to be dynamic outputs of the generator module 12. As new users for a customer are added, their POPs are identified and added to the service definitions. As old users disappear, so possibly, can their POPs. If an administrator changes a parameter such as cost, then it gets changed during the development of the new service definition. The system is organized such that most meta-service parameter values accept regular expressions or wild cards as well as specific entries. This along with the use of hierarchy in most of them, results in a very compact and efficient specification process.

The system instantiates a service object for each sub-service and customer in the set. For example, if the network has four customers (opticom, opticom/East, opticom/East/MA, opticom/Europe), and has four services (webservice, webservice/Andover, webservice/London, and webservice/Sacramento), and each customer has one or more users in each service area; then there exists sixteen different instances that are the cross products of the customers and services. This structure allows the system to segregate customer data about services so that each instance has only data that pertains to its particular customer.

Usergroups 16 are collections of users that are all owned by a particular customer. In this illustrated embodiment, a service contains usergroups that in turn contain elements. An element may be shared by multiple usergroups. This means that any given POP may be the access point of multiple users of multiple customers. In one embodiment, the system handles this one-to-many correspondence by having as many unique instances of a usergroup as there are customers and services that contain it. A suitable naming convention for each usergroup instance is ‘customer_name|service_name|usergroup_name’. Each of the name components may be hierarchal, as described above. An alternate implementation utilizes a single usergroup for a location, a single service, and a single customer, and specifies a mesh of inter-relationships that would have to be navigated for the appropriate context. However, the preferred implementation is the first one, providing a static mapping that is created at the time the meta-service generator defines services (e.g., daily in the above example).

As shown in FIG. 1A, the meta-service generator module 12 receives a start-of-day message, and operates to delete the previous service definitions—e.g., all files whose name starts with “auto—”. The module receives the daily inventory, e.g., a set of POPs (points of presence, i.e., ports through which a user may access the system). These may, for example, be selected as elements with three or more ports having a support relationship for the customer that owns the service. Meta-service templates are applied to this input data to produce a set of service definitions based upon the location attributes of the set of POPs selected from the inventory. In this embodiment, only POPs that have a supports relationship are used. With reference to FIG. 1B, in the event the system is implemented with proto-service definitions, instead of the meta-service route, a proto service module 18 deletes daily at the start of day all files whose names start with “proto—” and applies each proto-service template in its file to produce a single updated service definition 14. After all service definitions are completed, all the services in the services directory are loaded and each UserGroup/Pop definition 16 is instantiated using inherited variables.

By way of example, POPs inherit outage definitions formulae from a Usergroup, that inherits it from a service, that inherits it from a meta-service. In real time, the POP is registered for callbacks with an element outage collector for every element named in its outage definition formula.

The meta-service module may be set up such that all variables are passed to the service definitions as is, with Regular Expression or Wildcard defined variables. As each usergroup/Pop is instantiated, the variables are processed for Regular Expression or Wildcards using the location of the usergroup/Pop.

The meta service rules may, by way of example, be implemented in a basic embodiment with the following syntactic rules. A brief description is given of the operation of each set.

Service name=<name>semantic property is service_name [, <service description>]<service description>::=<service naming hierarchy>[,<POP naming hierarchy>[, <usergroup naming hierarchy>]]<service naming hierarchy>::=service naming options are <service naming options> [, <levels>]<levels>::=levels =<level list><level list>::=<integer>|<integer>, <level list><service naming options>::=<location>|<element name>|<addressing>|<network>|<topology><location>::=location, tag [<location levels><location>semantic —>

Thus, the global set of location names are broken down hierarchically using either ‘/’, ‘\’, or “.” as delimiters and collected in a tree structure; the resulting tree nodes are inspected via the levels definition, and a set of names are derived. Then the cross product of customer names derived from the customer configuration list and the services are used to instantiate a service instance for each element of the cross product.

<element name>::=name, tag <element name>semantic—>

The global set of element names are broken down hierarchically using same delimiters as location and process as described for location.

<addressing>::=address, tag [=<protocol precedence list >, <mask list>]<addressing>semantic—>

For the global set of elements, the system looks up their associated network addresses. Based upon the protocol precedence list, those addresses are processed against the mask lists for the protocols to identify a number of unique suffixes. The mask list allows assigning either ranges, bit masks, or specific addresses to a hierarchical symbol structure that is then processed via the level rule to provide the resulting set of suffixes.

<network>::=network, tag <network>semantic—>

The global set of network unique names for each element are retrieved from the set of directory services and hierarchically broken down using the appropriate delimiters. The remainder of the process is as defined for location

<topology>::=topology, tag [=<Enterprise system>, <containment list>]<topology>semantic—>

This deals with a proprietary structure. An example is that CS/Aprisma's Spectrum Enterprise Management System builds a network hierarchy for managing a network. The network structure is a combination of the domain structure and LAN/WAN containers. Each container has a set of components that are interconnected in complex ways with links that are appropriate to the containers definition. Each containment is composed of subordinate containers. Any physical element can be uniquely located within the containment structure. The full name of the elements using this containment structure are decomposed to build the set of service names using the process described for location.

<POP naming hierarchy>::=POP naming options are <POP naming options>[,<levels>]<POP naming options>::=<element name><usergroup naming hierarchy>::=usergroup naming options are <usergroup naming options>[,<levels>]<usergroup naming options>::=<element name><cost assignment rule>::=cost_per_ium =<cost rule>|cost_per_ium/<hierarchy rule>=<cost rule><cost rule>::=value |formula <hierarchy rule>::=<regular expression><sla assignment rule>::=SLA=<SLA rule>|SLA/<hierarchy rule>=<SLA rule><SLA rule>::=<SLA Format><SLA Format>semantic—>

A file within the html directory that is processed against the service definition to produce an html document of the specific SLA

<customer assignment rule>::=customer=<name>|customer/<hierarchy rule>=<name>|customer/<hierarchy rule>=<regular expression><port counting rule>::=percent of ports=<value>0-100 <user counting rule>::=users=<user assignment formula>|users=<value>|users/<hierarchy rule>=<user assignment formula><user assignment formula>semantic—>

This uses port type, bandwidth, and topology information to assign a number of users to a port. For some types of devices which are network access ports, the device maintains a list of addresses (usually MAC addresses) of the end stations that are accessible via the port. Other devices have routing tables that give similar information. For those devices that do not provide this information, proprietary rules are implemented that use port type, bandwidth, and topology information (whether or not this is a gateway port in the network) to assign a number of users to the port.

Various dependency rules, such as those listed below, operate to set necessary formulae, select scope or modify relevant data.

<dependency rules>::=<dependency rule>|<dependency rule><dependency rules><dependency rules>::=require=<dependency expression>|require/<hierarchy rule>=<dependency expression><dependency expression>::=(<dependency expression>) |<dependency expression> and <dependency expression>|<dependency expression> or <dependency expression>|<network dependency>|<network dependency>|<server dependency><network dependency>::=network(<net dependency tree>) <server dependency>::=server(<server dependency tree>) <net dependency tree>::=NULL |<element name>|<element name> and <net dependency tree>|<element name> or <net dependency tree>|(<net dependency tree>) <server dependency>::=<net dependency tree><contracted time>::=<period specification>|<period specification> <contracted time><period specification>::=hours=<period and day spec>|hours/<hierarchy rule>=<period and day spec><period and day spec>::=<start time>/<stop time>/<day list><daylist>::=<integer>|<integer><daylist><daylist>semantic—>list of integers 0-6 in ascending sequence 0=monday <availability threshold>::=availabilty <threshold expression><performance threshold>::=performance <threshold expression><error threshold>::=error <threshold expression><threshold expression>::=threshold=<threshold value expression>|threshold/<hierarchy rule>=<threshold value expression><threshold value expression>::=<value>[, <value>[,<value>]]

In general the system may define each service with an auto generation flag, a lowest level service flag, service name, customer name, and SLA or user specific data such as cost per item for service, list of user groups, and contracted hours. The service syntax is:

service <service name>generate SLA <format>generate dependencies customer <customer name><contracted hours>hours <start><stop>/ <day list>availability threshold <value>[<value>[<value>]]performance threshold <value>[<value>[<value>]]error threshold <value>[<value>[<value>]]<bundle of user groups>usergroup <ug name><POPname><usercount>[<cost_per_ium>]require <requirement trees>

Similarly, the system may pull out relevant SLA information, such as Customer Name, Number of users, Contracted Hours, Performance metrics, Quality metrics, Thresholds for performance, Thresholds for availability and Thresholds for Quality.

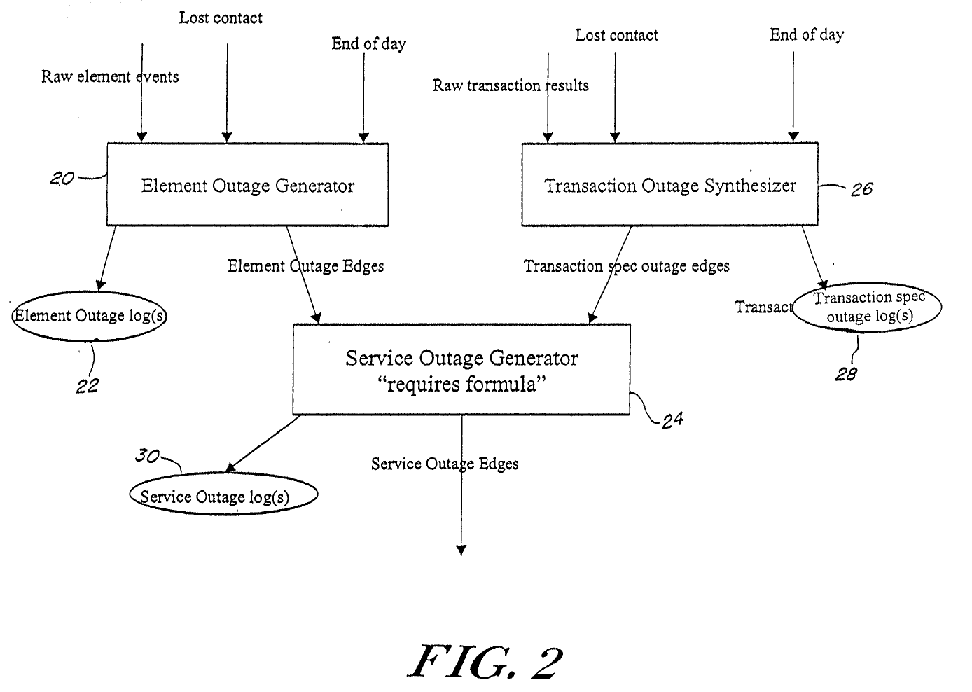

Given the definitions of services, systems of the present invention then determine outages and apply various metrics to performance of the network. FIG. 2 illustrates operation of the system to recognize service outages. In this illustrative embodiment, the system runs in continuous mode, with an element outage generator 20 processing element events to establish element outages. These are captured daily (or at other set intervals) in element outage logs 22 and each element event, as it is processed, is passed off to the continuous part of a Service Outage Generator 24 that saves the last state of all those elements for which it has registered interest (e.g., as identified by the service definition). Thus, the edges (when an element goes “up” or “down”) pass to the service outage generator.

As further shown in FIG. 2, another module 26, herein referred to as Transaction Outage Synthesizer, operates on a stream of raw transaction monitoring data, performing equivalent action on the transaction side to identify transaction outages (which may include out of spec “outages”, when transaction performance speed or number have dropped below a threshold). This module similarly compiles a Transaction spec outage log 28 and also passes a stream of outage edges to the service outage generator module 24.

The Service Outage Generator thus receives the event outage and the transaction outage streams. It gets called on every element event or transaction result that it has registered for, and it re-evaluates the ‘requires’ formula for each callback. The Service Outage Generator 24 compiles a service outage log 30.

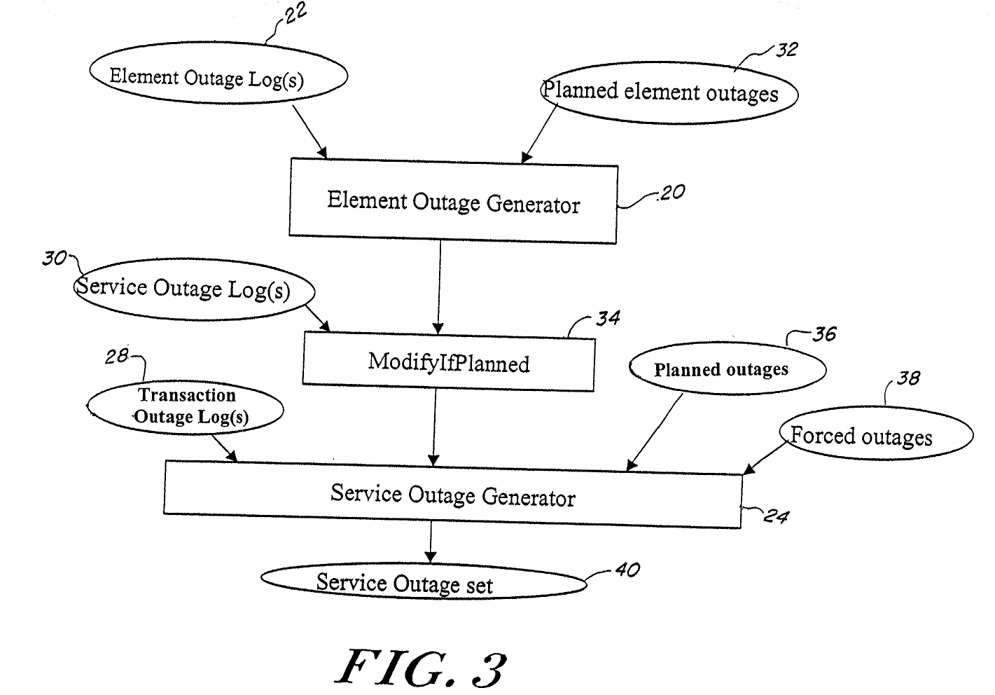

The service monitoring system of the present invention is preferably also configured to perform batch processing of element and transaction outage records. FIG. 3 shows the historical or batch processing of service outages. All reports correspond to a specific period of time, e.g., a specific period of hours, days, or weeks. In this case, the element outage logs 22 and the service outage logs 30 are used as raw input. It will be understood that these logs will typically represent outages detected by specific element monitoring steps or hardware signaling devices, and by transaction polling or monitoring steps. However, when the service evaluation is to be applied to assess specified SLA performance levels, it would be appropriate to ignore an element outage if it occurred during a planned element outage, rather than count it as an unintended loss of service. Similarly, if the transaction outage logs indicate a below-threshold level of performance during a planned outage (when the particular service was not required to be provided), again the outage should not be counted as an SLA breach, and no damage can be ascribed to it.

Systems of the invention address this complexity by determining the extent of concurrency of the various raw element or transaction outages with planned element or service outages. Forced outages—that is those reported by users but not necessarily detected by the SNMP—may also be factored into the final results. This is done at several levels. As shown in FIG. 3, the system first performs batch outage processing to build a set of element outages that consist of observed and planned element outages 32. A concurrence algebra is employed to build this new set reflecting the fine structure of the outage types. A Modify if Planned module 34 then merges the stream of element outages with the service outages to determine which portions of the service outages are planned element outages; the remainder are observed service outages. The service outage generator 24 then merges these outages with planned service outages 36, forced service outages 38, and transaction specification outage logs 28 using a concurrence algebra to produce a stream of service outages of the appropriate types. The resulting service outage set 40 is then processed by the report to produce the service metrics.

The concurrence algebra sets forth the logical relation between the normally-detected outages O, planned outages P (i.e., administratively planned outages), and forced outages F (i.e., administratively forced, where a user observed an outage, and the administrator manually entered it in the logs). For any instance in time, if there is one or more observed outage (determined by the continuous outage generators) then we have O. If there are no observed outages, then we have Not O. If there is one or more planned outage, then we have P, and if there are no planned outages, then we have Not P. If there is one or more forced outage, we have a F. If there are no forced outages, then we have Not F.

The following service outage concurrence algebra may be applied to the outage states to produce a modfied outage output set.

(Not O) and (Not P) —>Not O (Not O) and (Not F) —>Not O (Not O) and (Not F) and (Not P) —>Not O P and (Not O) —>Not O F and (Not O) —>F P and F —>F O and P —>P O and F —>O O and P and F —>F

In a like manner, an element outage concurrence algebra may be applied by the element outage generator to the element outage inputs to produce a suitably modified element outage set that is then passed to the service outage module as an input for service outage generation. This may be

(Not O) and (Not P) —>Not O (Not O) and P —>Not O O and (Not P) —>O O and P —>P

In each case, the algorithm of the generator is to break all outages for the time period into a starting edge and a completion edge with times for each. All outage edges are then sorted by their time of occurrence, and edges are processed in order. Thus, there is an O stack, a P stack, and an F stack, and the initial state is Not O. For each edge, if it is a starting edge, the outage is added to its appropriate stack and if it is a completion edge, it is removed from its appropriate stack. At each edge, the generator re-evaluates its state based upon the concurrence algebra, and if the state has changed, it stacks a state change; if the time is greater than any stacked state changes they are flushed out as appropriate outages. If the time is the same as a previously stacked state change, the generator flushes the stacked changes (thus eliminating zero-length outages that would be created when multiple edges occur at the same point in time).

A special case may occur when various planned events overlap detected state changes of elements in the system. Each observed service outage has to be broken into one or more outages that may be either observed or planned based upon the element outages. The generator has to build a set of element outages for the set of elements that appear in the original service outage definition rule that are within the time scope of the service outage being considered. These are processed into a sequence of planned or observed outages that are entered into the service outage generator in lieu of the service outages. However, in practice, the service outage generator may only use the observed service outages to resolve anomalies between continuous processing and batch processing. If the batch processing fails to generate an outage for a time at which a service outage occurs, the generator output may defer to the service outage log for that period and assume that the service outage is accurate. This approach may be taken to handle transaction caused outages. Put another way, in continuous time, the system may determine that there is a service outage because one or more transactions failed a threshold. When the batch time processing does not indicate an element-caused service outage, then it is assumed that a transaction induced outage existed.

Since the element outage concurrence algebra is a true subset of the service outage concurrence algebra, the same calculations may be used, assuming we will never see an edge for a forced outage, thus we will always have the Not F state.

It will be understood that the element and service outages may be further processed by a reporting module that may for example, produce reports regarding outage duration, cumulative downtime, availability of elements and services, an average time period between failures and other performance level or service level measurements. The Reporting facility can further provide trending or statistical reports, or other reports as described in the above-referenced patent application. The service monitor may collect data from multiple data sources at a central system, and provide reports and notifications to different entities from that system, or operate with file transfers to provide data for local generation of necessary notifications and desired reports.

It will be appreciated that the invention provides an improved and client server based model for monitoring and reporting services that may be widely distributed, and may be composed of other services. By providing meta-services with usergroups and POPs as subsets of the services, the system addresses a large volume of data and produces focused subsets for report generation. Those having ordinary skill in the art will appreciate that various modifications can be made to the above illustrative embodiments without departing from the scope of the present invention. The invention being thus disclosed, variations and modifications thereof will occur to those skilled in the art, and such variations and modifications are considered to be within the scope of the invention, as defined by the claims appended hereto and equivalents thereof.

What is claimed is:

1. A system for use in a computer network to monitor and record outage status of a service provided on the network, wherein the system comprises:
a meta service generator operative on network inventory to define a service definition, each service definition including usergroup and point of presence;
a first module receiving element event data corresponding to changes in a state of elements associated with said defined service and creating element outage data indicating outage events associated with each of said elements;
a second module for receiving transaction data and determining transaction outages, and
a third module operative on output data from said first and second modules to determine sevice outages.

2. A system according to claim 1, wherein said first module includes an Event Stream Merger for receiving said element event data and creating a merged event stream containing said element event data in time sequence.

3. A system according to claim 1, wherein said first and second modules produce an element outage log and a transaction spec outage log, respectively, and further comprising a batch processing system operative on said logs for generating service outage reports.

4. A system according to claim 3, wherein said batch processing system includes an historical element outage generator, the historical element outage generator operating with said element outage logs and records of planned element outages to produce modified element outage data.

5. A system according to claim 4, wherein said batch processing system includes an historical service outage generator, the historical service outage generator operating with said modified element outage data and with said transaction spec outage logs to determine service outages.

6. A system according to claim 5, wherein said outage generator modifies service outage data in accordance with at least one of planned and forced outages to determine said service outages.

7. A system according to claim 1, wherein said meta service generator operates at a predefined period to define service objects for operation on a stream of element state data.

8. A system according to claim 1, further comprising a service outage reporting facility receiving data from said third module and presenting to a user an SLA based report.

9. In a network, a method for monitoring and recording outage status of a service provided on the network, said method comprising the steps of:
providing a meta service generator, said meta service generator periodically receiving a system inventory and operating thereon to determine service definitions;
providing a plurality of element event data streams, each indicating a change in status of a selected element associated with a service definition;
merging said element event streams into an output stream containing said event streams in time sequence and determining outage events of said selected elements from said merged output stream; and
using said outage events to create service reports.

10. A method according to claim 9, wherein a service definition includes usergroup and points of presence for selecting events relevant to the defined service.

11. A system for reporting service level and service outages on a network, wherein the system receives element outage logs and service outage logs, and produces a service outage output corrected for planned and/or forced outages so that the service outage output may better reflect at least one of
deficiencies under a contracted set of service levels, and
service outages actually experienced by users of the network.
